(19) United States
(12) Patent Application Publication
(10) Pub. No.: US 2009/0251623 A1
(43) Pub. Date: Oct. 8, 2009

(54) INDICATION DEVICE AND INFORMATION PROJECTION SYSTEM

(75) Inventor: Fumio KOYAMA, Hara-mura (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/419,476

(22) Filed: Apr. 7, 2009

(30) Foreign Application Priority Data
Apr. 8, 2008 (JP) 2008-100055
Jan. 22, 2009 (JP) 2009-011674

(51) Int. Cl. H04N 5/64; G06F 3/033

(52) U.S. Cl. 348/789; 345/179; 348/E05.128

(57) ABSTRACT

An indication device includes an indication unit pointing to an indication position which is a position on an indicated surface on which first information is displayed; an information projection unit which projects second information onto the indicated surface; and a process execution unit which executes a process appropriate to an indication position pointed to by the indication unit.

### BACKGROUND

1. Technical Field

The present invention relates to a technology which projects information onto an indicated surface, such as a paper surface or a display medium.

2. Related Art

There is a technology which indicates an indicated surface using a pen-like indication medium such as a stylus pen or a light pen. Herein, the indicated surface is a paper surface, which displays information unchangingly, or a display medium, such as electronic paper, which displays information changeably. Among technologies which detect a position on a paper surface, there is one which reads a predetermined graphic of microdots or the like (for example, refer to JP-T-2003-511761 and JP-A-2005-309636). Also, regarding technologies which detect a position on a display medium, one example thereof has been invented by the inventor of the present invention (refer to Japanese Patent Application No. 2007-076103).

In the event that the indicated surface is a display medium, the display medium, by rewriting its display details, can display information appropriate to an indication by the indication medium on the indicated surface. Meanwhile, in the event that the indicated surface is a paper surface, it is not possible to display new information on the indicated surface unless the display details on the paper surface are rewritten with a writing implement or the like.

### SUMMARY

An advantage of some aspects of the invention is, when indicating an indicated surface using an indication medium, to display information on the indicated surface without rewriting the display details of the indicated surface.

An indication device according to one aspect of the invention includes an indication unit pointing to an indication position which is a position on an indicated surface on which first information is displayed, an information projection unit which projects second information onto the indicated surface, and a process execution unit which executes a process appropriate to an indication position pointed to by the indication unit. According to this configuration, it is possible to display information on the indicated surface by means of a projection from the information projection unit, regardless of whether or not there is a rewriting of the indicated surface.

It is also acceptable that the indication device according to this aspect of the invention is of a configuration wherein the information projection unit projects information in accordance with execution details, an execution form, or an execution result of a process by the process execution unit as the second information. According to this configuration, it is possible to display information in accordance with a process by the process execution unit, regardless of whether or not there is a rewriting of the indicated surface.

It is also acceptable that the indication device according to this aspect of the invention is of a configuration wherein the indication device includes a storage unit which stores the second information corresponding to the first information for each position in which the first information is displayed, and a specification unit which specifies the indication position pointed to by the indication unit, wherein the process execution unit retrieves the second information corresponding to the indication position specified by the specification unit from the storage unit, and supplies it to the information projection unit, and the information projection unit projects the second information supplied by the process execution unit. According to this configuration, in the event that the first information displayed on the indicated surface is pointed to, it is possible to project the second information corresponding to the first information.

It is also acceptable that the indication device according to this aspect of the invention is of a configuration wherein the indication unit changes the indication position in response to an operation by a user, and the information projection unit projects information prompting an operation by the user. By so doing, it is possible to notify the user of a necessary operation.

An information projection system according to another aspect of the invention includes an indication device having an indication unit pointing to an indication position which is a position on an indicated surface on which first information is displayed, a first process execution unit which executes a process appropriate to an indication position pointed to by the indication unit, and an information projection unit which projects second information onto the indicated surface. The system also includes a display device having a display unit which displays the first information on the indicated surface, and a second process execution unit which executes a process appropriate to an indication position pointed to by the indication unit. According to this configuration, it is possible to display information on the indicated surface by means of a projection from the information projection unit, regardless of whether or not there is a rewriting of the indicated surface.

It is also acceptable that the information projection system according to this aspect of the invention is of a configuration wherein the indication device has a first communication unit which carries out communication with the display device, and a reading unit which reads position information expressing the indication position pointed to by the indication unit, wherein the first process execution unit transmits the position information read by the reading unit, or display information corresponding to the position information, via the first communication unit to the display device. Also, the display device has a second communication unit which carries out communication with the indication device, and a rewriting drive unit which rewrites the first information displayed by the display unit, wherein the second process execution unit causes the rewriting drive unit to carry out a rewriting in accordance with the position information or display information received from the indication device via the second communication unit. According to this configuration, it is possible to rewrite the display details of the display device in accordance with the position indicated by the indication device.

It is also acceptable that the information projection system according to this aspect of the invention is of a configuration wherein the indication device has an electromagnetic wave generator which generates an electromagnetic wave, and the display device has a detection unit which detects the electromagnetic wave generated by the electromagnetic wave generator in a plurality of positions on the indicated surface, and the rewriting drive unit which rewrites the first information displayed by the display unit, wherein the second process execution unit causes the rewriting drive unit to carry out a rewriting in accordance with the position in which the detection unit detects the electromagnetic wave. According to this configuration, it is possible to give the display device a rewriting instruction by means of a change in light or magnetic flux.

It is also acceptable that the information projection system according to this aspect of the invention is of a configuration wherein the information projection unit carries out a projection in response to a reading of the position information or display information by the reading unit. According to this configuration, it is possible to notify the user, by means of a projection, of the availability of a reading, or the like.

It is also acceptable that the information projection system according to this aspect of the invention is of a configuration wherein the indication device includes an identification unit which identifies the first information displayed on the indicated surface after the rewriting by the rewriting drive unit, and the information projection unit carries out a projection in accordance with the identification by the identification unit. According to this configuration, it is possible to specify display details, without receiving a supply of information relating to the display details from the display device.

It is also acceptable that the information projection system according to this aspect of the invention is of a configuration wherein the information projection unit carries out a projection in accordance with the condition of the communication by the first and second communication units. According to this configuration, it is possible to notify the user of the condition of the communication.

It is also acceptable that the information projection system according to this aspect of the invention is of a configuration wherein the first communication unit has a primary coil which generates an electromagnetic wave, the second communication unit has secondary coils, in a plurality of differing positions, which are electromagnetically coupled with the primary coil, and the second process execution unit varies the form of the rewriting in accordance with the position of the secondary coil electromagnetically coupled with the primary coil. According to this configuration, it is possible to give the display device a rewriting instruction by means of a change in magnetic flux.

### BRIEF DESCRIPTION OF THE DRAWINGS

The invention will be described with reference to the accompanying drawings, wherein like numbers reference like elements.

FIG. 1 is a diagram showing a configuration of an information projection system.

FIG. 2 is a diagram showing an external appearance of an indication device.

FIG. 3 is a block diagram showing a configuration of the indication device.

FIG. 4 is a diagram showing an external appearance (indicated surface) of a display device.

FIG. 5 is a block diagram showing a configuration of the display device.

FIG. 6 is a diagram for illustrating overwrite information.

FIG. 7 is a diagram for illustrating overwrite information.

FIGS. 8A to 8E are diagrams exemplifying information projected onto the indicated surface.

FIG. 9 is a diagram showing a configuration of an information projection system.

FIG. 10 is a block diagram showing a configuration of an indication device.

FIG. 11 is a functional block diagram showing functions of the indication device.

FIG. 12 is a diagram showing a configuration using secondary coils as a way of specifying an indication position.

### DESCRIPTION OF EXEMPLARY EMBODIMENTS

A first embodiment to be described hereafter is an embodiment of a case in which the indicated surface is a display medium. Also, a second embodiment is an embodiment of a case in which the indicated surface is a paper surface. Herein, a “paper surface” refers to a display carrier which displays information unchangingly, and is not particularly limited to paper. Also, herein, “unchangingly” means that no electrical rewriting is carried out. Therefore, it is acceptable that the paper surface referred to herein does not prevent a rewriting of displayed information with a writing implement or the like.

### First Embodiment

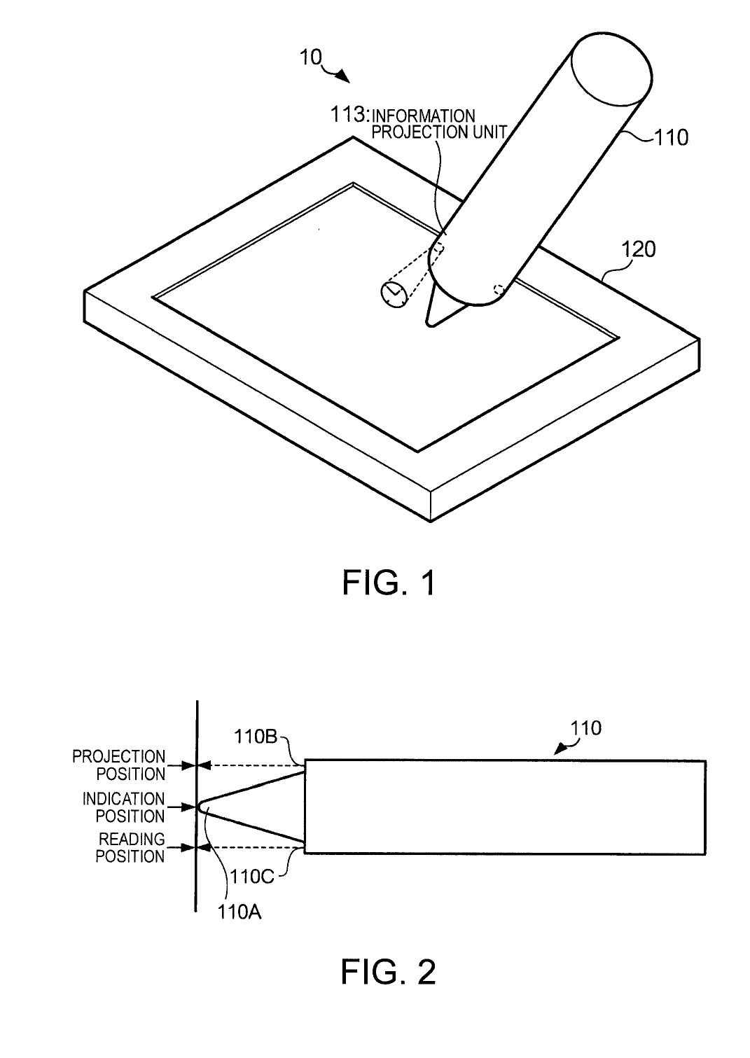

FIG. 1 is a diagram showing a configuration of an information projection system which is a first embodiment of the invention. As shown in the diagram, an information projection system 10 of the embodiment includes an indication device 110, and a display device 120. The indication device 110, being a pen-like indication medium which can project information, is an object with which a user carries out an operation of pointing to the display device 120. The display device 120 is a display device which has an indicated surface indicated by the indication device 110 on at least one of its surfaces. In the embodiment, the display device 120 is so-called electronic paper.

FIG. 2 is a diagram showing an external appearance of the indication device 110. As shown in the diagram, the indication device 110 having a rod-shaped external appearance, one extremity thereof is configured in such a way as to point to a predetermined position on the display device 120. This extremity portion is an indication portion 110A. It is desirable that the shape of the indication portion 110A is such that it becomes narrower as it heads toward the leading extremity so as to, without preventing the user from seeing the indicated surface, make clearer the position indicated thereon. Also, an aperture 110B and an aperture 110C are provided in a vicinity of the indication portion 110A. The aperture 110B is an aperture provided for projecting information, while the aperture 110C is an aperture provided for reading information displayed on an indicated portion. The apertures 110B and 110C each open onto the leading extremity side of the indication portion 110A.

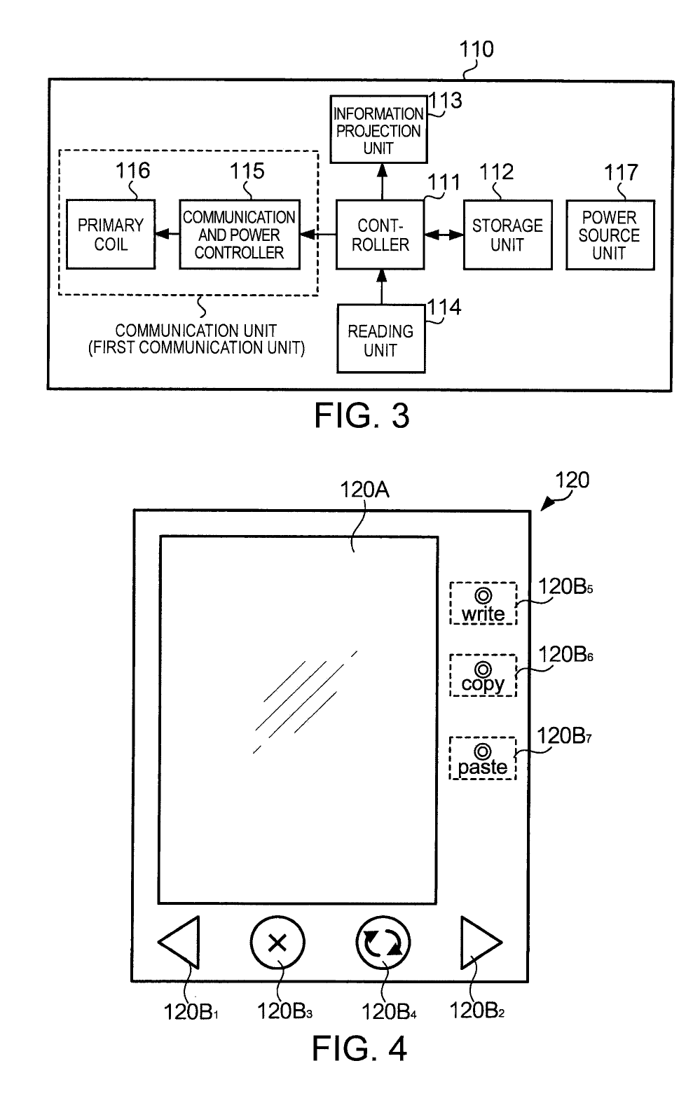

FIG. 3 is a block diagram showing a configuration of the indication device 110. As shown in the diagram, the indication device 110 includes a controller 111, a storage unit 112, an information projection unit 113, a reading unit 114, a communication and power controller 115, a primary coil 116, and a power source unit 117. The controller 111, including a calculation device, such as a central processing unit (CPU), and a memory, controls an operation of the indication device 110 by executing a process in accordance with a program stored in advance. The storage unit 112, including a rewritable recording medium, stores information used in the process by the controller 111. It is acceptable that the storage unit 112 is attachable to and removable from the indication device 110, like a so-called memory card.

The information projection unit 113, including a mechanism which projects information on a character, an image, or the like, projects information from the aperture 110B. The mechanism which projects information, being, for example, a so-called microprojector, projects desired information by controlling tones of a plurality of pixels. While it is acceptable that the information projected by the information projection unit 113 is monochromatic, it is more desirable that it can express a greater number of colors by an additive mixing of red, green, and blue.

The reading unit 114, including a mechanism which reads information displayed on the indicated surface, reads information from the aperture 110C. The mechanism which reads information includes, for example, an imaging element such as a charge coupled device (CCD). The reading unit 114 generates image data expressing the information read, and supplies the generated image data to the controller 111. Although it is sufficient that the image data are monochromatic in the event that the information to be read is monochromatic, in the event that the information to be read is polychromatic, the data express colors appropriate to the information to be read.

It is acceptable that the reading unit 114 is of a configuration whereby, a switch which enables or disables an execution of a reading being provided, it carries out a reading when the user instructs an execution using the switch. By so doing, as well as suppressing power consumption, it is possible to arrange in such a way as not to carry out a reading which the user does not intend.

A position onto which the information projection unit 113 projects (hereafter called the “projection position”), and a position from which the reading unit 114 reads (hereafter called the “reading position”), are both in the vicinity of the leading extremity of the indication portion 110A. Although the “vicinity” referred to here is not one whose specific range is particularly fixed, it is desirable that it is of a range which the user can see at the same time as the indication portion 110A. For example, the projection position is within a range of a few millimeters to 20 millimeters above the leading extremity of the indication portion 110A when the user brings the indication portion 110A near the indicated surface, and the reading position is within a range of a few millimeters to 10 millimeters below the leading extremity of the indication portion 110A when the user brings the indication portion 110A near the indicated surface. It is acceptable that the up-down relationship between the projection position and the reading position is the reverse of that heretofore described, and it is also acceptable that the relationship is left-right rather than up-down. Also, it is also acceptable that the information projection unit 113 and reading unit 114 are provided in such a way as to share one aperture.

The communication and power controller 115 and primary coil 116, moving in concert, function as a first communication unit in some aspects of the invention. The communication and power controller 115 controls communication and power supply carried out via the primary coil 116. The communication and power controller 115 modulates a predetermined carrier wave based on information supplied from the controller 111, and supplies a current corresponding to a modulation wave signal to the primary coil 116. The primary coil 116, being one example of an electromagnetic wave generator in some aspects of the invention, includes a coil embedded in the vicinity of the leading extremity of the indication portion 110A. The primary coil 116 generates an electromagnetic wave in accordance with the supplied current, inducing an electromagnetic connection with secondary coils 121, to be described hereafter. The method of modulating with the communication and power controller 115 is not an issue.

The power source unit 117 supplies power for the controller 111, the storage unit 112, the information projection unit 113, the reading unit 114, and the communication and power controller 115 to operate. The power source unit 117 includes, for example, a primary battery or secondary battery.

Display data, layout information, and context information are included in the information stored by the storage unit 112. The display data, being data expressing information displayed by the display device 120, are one example of display information of some aspects of the invention. Characters and images are included in the information expressed by the display data. The display data, existing in units of one page, have identification information which identifies each page. The identification information, including information expressing the order of the pages, is configured in such a way that it is possible to specify a page following, and a page preceding, a certain page. The layout information is information in which are described a function allotted to each indication position on the indicated surface, and a position (coordinates) of a character or image being displayed on the display device 120. That is, the layout information is information for identifying whatever information each indication position on the indicated surface has. Therefore, in the event that the information displayed on the display device 120 is rewritten, the layout information is updated in accordance with the rewritten new display details. The context information is information which expresses display data being displayed on the display device 120. It is more desirable that the context information, in addition to the information expressing the display data being displayed on the display device 120, includes information which expresses previously displayed display data as a history.

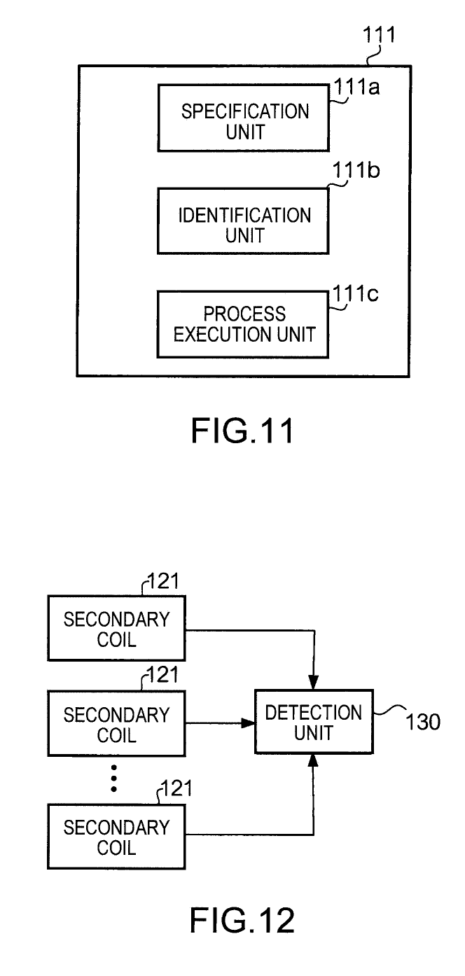

FIG. 11 is a functional block diagram showing functions realized by the controller 111. The controller 111, by executing a program stored in advance, realizes a specification unit 111a, an identification unit 111b, and a process execution unit 111c. The specification unit 111a has a function of specifying a position pointed to by the indication unit 110A, that is, an indication position. The identification unit 111b has a function of identifying the display details of the display device 120 indicated surface. The identification unit 111b identifies the display details of the indicated surface based on the layout information stored in the storage unit 112. The process execution unit 111c has a function of executing processes appropriate to an indication position indicated by the indication device 110, in accordance with the results of the processes of the specification unit 111a and identification unit 111b. A process for specifying the user's operational details, and a process for transmitting information to the display device 120, are included in the processes executed by the process execution unit 111c. The process execution unit 111c corresponds to a first process execution unit in some aspects of the invention.

FIG. 4, being a diagram showing an external appearance of the display device 120, shows the indicated surface. The indicated surface of the display device 120 of the embodiment is divided into a display surface 120A and operation surfaces 120B (120B₁ to 120B₇). The display surface 120A is an indicated surface which variably displays information. That is, information displayed on the display surface 120A can be electrically rewritten. On the other hand, the operation surfaces 120B are indicated surfaces on which information is fixed and displayed by printing or the like. It is assumed that the information displayed on the operation surfaces 120B is information which cannot be rewritten.

Also, information for specifying each position (indication position) is displayed on the indicated surface of the display device 120 by means of printing or the like. This information will hereafter be called “code information”. The code information is one example of position information of some aspects of the invention. The code information is, for example, a pattern of microscopic dots of the kind described in JP-T-2003-511761 or JP-A-2005-309636, but what pattern a position (that is, coordinates) is expressed by is optional. It being sufficient that such code information is readable by the reading unit 114, it is desirable that it is not seen (or is unlikely to be seen) by the user. The code information displayed on the display surface 120A of the embodiment is this kind of code information. Also, the code information not being limited to the heretofore described example, it is also acceptable that it is, for example, a graphic or symbol expressing a predetermined meaning, and it is also acceptable to distinguish the graphic or symbol by color. It is also acceptable that the code information displayed on the operation surfaces 120B is this kind of code information.

In the embodiment, a predetermined function is allotted to each of the operation surfaces 120B. Hereafter, each of the operation surfaces 120B will be called an “operation point”. Functions which are triggers for a rewriting of information displayed on the display surface 120A are allotted to the operation surfaces 120B₁to 120B₄. The function allotted to the operation surface 120B₁ (a first operation point) is a function (a page return function) for making the information displayed the information of one page before. The function allotted to the operation surface 120B₂ (a second operation point) is a function (a page forward function) for making the information displayed the information of one page after. The function allotted to the operation surface 120B₃ (a third operation point) is a function (an overwrite delete function) for deleting overwritten information, to be described hereafter. The function allotted to the operation surface 120B₄ (a fourth operation point) is a function (an overwrite update function) for updating overwritten information.

Also, functions which are triggers for an input of overwritten information are allotted to the operation surfaces 120B₅ to 120B₇. The function allotted to the operation surface 120B₅ (a fifth operation point) is a function (a write function) for displaying a handwritten dot or line in a position to be indicated subsequently. The function allotted to the operation surface 120B₆ (a sixth operation point) is a function (a copy function) for copying information displayed in a position to be indicated subsequently. The function allotted to the operation surface 120B₇ (a seventh operation point) is a function (a paste function) for pasting and displaying the information copied by the function of the sixth operation point. By combining the copy function and paste function, it is possible to realize a so-called copy and paste.

The overwritten information is information overwritten on the display surface 120A in accordance with an operation by the user of the indication device 110. Details of the overwritten information will be described hereafter.

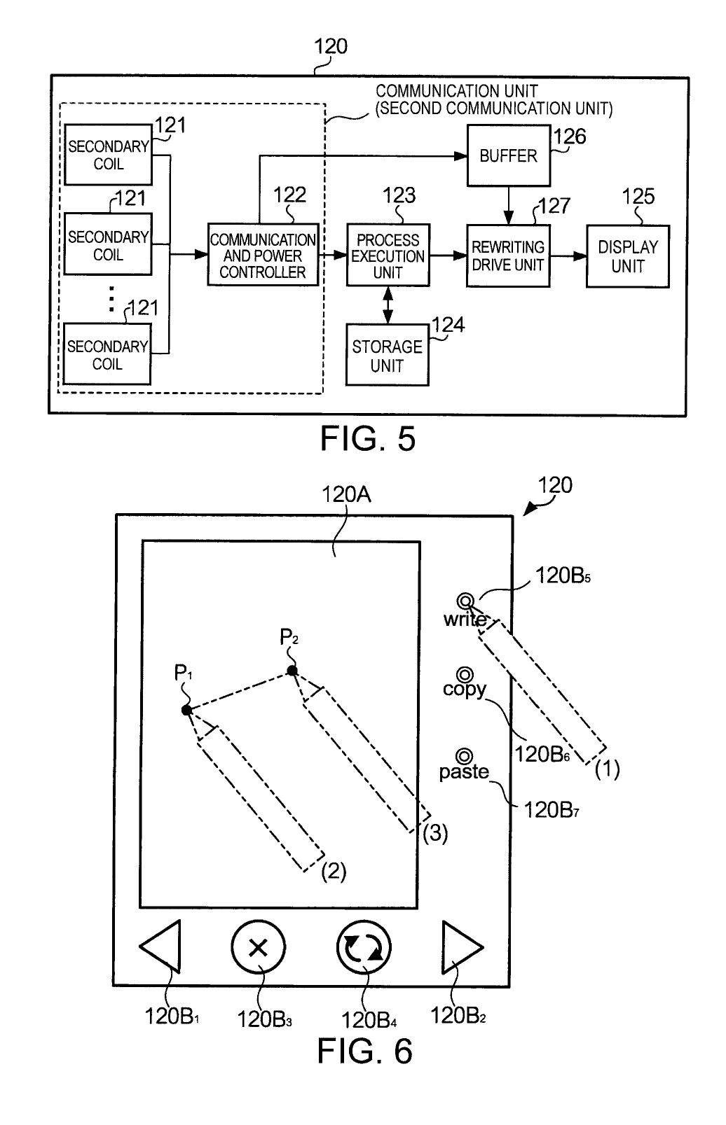

FIG. 5 is a block diagram showing a configuration of the display device 120. As shown in the diagram, the display device 120 includes a plurality of secondary coils 121, a communication and power controller 122, a process controller 123, a storage unit 124, a display unit 125, a buffer 126, and a rewriting drive unit 127. The secondary coils 121, being planar coils provided in such a way as to be aligned below one of the heretofore described first to fourth operation points, emit a current in accordance with a change in magnetic flux. That is, the number of secondary coils 121 in the embodiment is four. The communication and power controller 122, based on the current emitted by the secondary coils 121, acquires information and power transmitted from the indication device 110. The communication and power controller 122 carries out a demodulation process on the current emitted by the secondary coils 121, using a method appropriate to the modulation wave, and acquires the information transmitted from the indication device 110. Also, the communication and power controller 122 supplies the current emitted by the secondary coils 121 to each unit as power for the operation of the display device 120. The form of transmitting power using the communication and power controllers 115 and 122 is a so-called non-contact power transmission using electromagnetic induction. The secondary coils 121 and communication and power controller 122, moving in concert, function as a second communication unit in some aspects of the invention.

The process controller 123, including a calculation processing device, executes a process relating to a display on the display unit 125 using the power supplied from the communication and power controller 122. The process controller 123 includes a process execution unit 123a which realizes a function of causing the rewriting drive 127 to carry out a rewriting. The process execution unit 123a corresponds to a second process execution unit of some aspects of the invention. The storage unit 124, including a rewritable recording medium, stores information used in the process by the process controller 123. The information stored in the storage unit 124 is information, such as identification information, necessary for a display by the display unit 125.

The display unit 125, including an electrically rewritable display medium configured of a plurality of pixels, displays information corresponding to display data on the display surface 120A. The display medium of the display unit 125 is, for example, a memory-type display medium. Herein, a “memory-type display medium” refers to a display medium which, when a certain voltage is applied, displays information corresponding to the voltage, and also attempts to hold the displayed information in a condition, after the voltage has been applied, in which the voltage is not applied. As the memory-type display medium, it is possible to use, for example, a display medium using an electrophoresis element or a cholesteric liquid crystal. In the event that the display medium of the display unit 125 is a memory-type display medium, as the power for displaying information is unnecessary other than when rewriting, it is possible to achieve a reduction in the weight corresponding to the power source in the display device 120. Although the display device 120 of the embodiment is taken to be of a configuration which does not include a power source in the display device 120 itself, because it receives a supply of power from the indication device 110, this does not prevent the display device 120 from including an auxiliary power source.

The buffer 126, including a rewritable recording medium, temporarily stores display data to be supplied to the display unit 125. The rewriting drive unit 127, including a drive circuit which drives the display unit 125 display medium, carries out a drive in accordance with the display data stored in the buffer 126, and rewrites the display details of the display unit 125. The rewriting drive unit 127, specifically, applies a voltage to each pixel of the display unit 125 display medium in accordance with a tone in which it is to be displayed.

The configuration of the information projection system 10 of the embodiment is as heretofore described. With this configuration, the display device 120 displays information in the information projection system 10. The display device 120 is supplied with power from the indication device 110, and operates in accordance with an operation by the user using the indication device 110. The operation carried out by the user is an operation whereby the user, in a condition in which he or she grips the indication device 110, points the indication unit 110A of the indication device 110 at the indicated surface of the display device 120. At this time, the user brings the indication unit 110A near to the indicated surface, and carries out an operation of drawing a character or line, and holding the indication unit 110A so that it does not move. Although it is desirable that the indication unit 110A of the indication device 110, when being operated, is in contact with the indicated surface of the display device 120, it is also acceptable that there is a space between them, provided that it is slight.

Operations by the user are broadly divided into those carried out on the display surface 120A, and those carried out on the operation surfaces 120B (that is, the operation points). The operations carried out on the display surface 120A are the kind of operation of drawing a character or line, and an operation of indicating a position in which a copy or paste is to be carried out. All of these operations are carried out after the corresponding operation point, that is, one of the fifth to seventh operation points, has been indicated. Meanwhile, the operations carried out on the operation points are operations whereby a certain operation point is pointed at continuously for a predetermined time. The time for which the operation points are indicated, being the time needed for the indication device 110 to carry out the necessary process, is, for example, from one to a few seconds.

There are mainly three kinds of operation carried out by the indication device 110 in response to the operations by the user: 1. a specification of operation details, 2. a supply of power and information to the display device 120, and 3. a projection of the information onto the display device 120. Hereafter, each of these operations will be described along with the corresponding operations of the display device 120.

### 1. Specification of Operation Details

The indication device 110, carrying out a reading of the indicated surface when being operated, specifies the position being pointed to by the indication unit 110A, that is, the indication position. The specification of the indication position is carried out by, for example, the controller 111 acquiring image data, including the code information read by the reading unit 114, and the controller 111 specifying the code information based on the image data, and calculating the position from the code information. That is, the controller 111 functions at this time as the specification unit 111a which specifies the indication position. Then, the controller 111 executes a process appropriate to the specified indication position.

The controller 111, on specifying the indication position, specifies the details of the operation expressed by the specified indication position, based on the layout information stored in the storage unit 112. The controller 111, in the event that the specified indication position is included in the display surface 120A, stores the position information expressing the indication position in the memory, while in the event that the specified indication position is in the operation surfaces 120B (that is, an operation point), the controller 111 specifies the function allotted to the operation point, and stores the function information expressing the specified function in the memory. The controller 111, by specifying the position information and function information in this way, and storing them in the order specified, can specify the operation details, and store them. The position information and function information express overwrite information by a combination thereof.

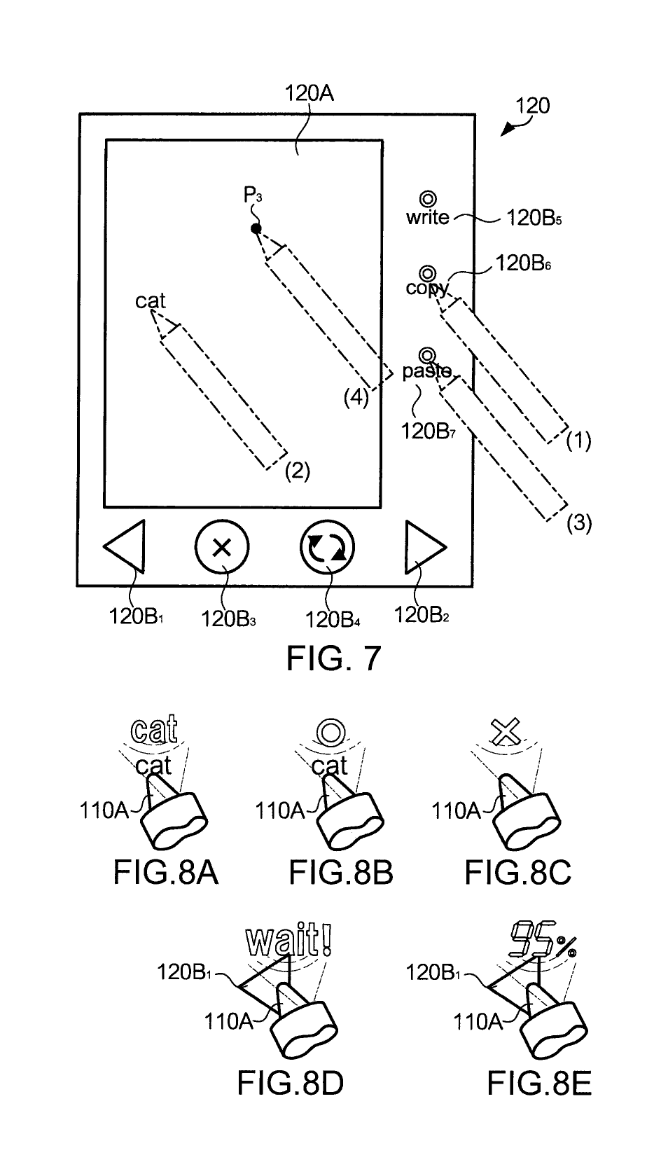

FIGS. 6 and 7 are diagrams for illustrating overwrite information. FIG. 6 is a diagram exemplifying with a case of displaying a straight line as overwrite information, while FIG. 7 is a diagram exemplifying with a case of displaying overwrite information wherein characters forming “cat”, displayed based on display data, are copied and pasted. The broken lines shown in the diagrams indicate the indication device 110, while the numbers 1 to 4 in the vicinity thereof indicate the order in which the indication device 110 moves. When carrying out the operation shown in FIG. 6, the user firstly indicates the fifth operation point, putting the indication device 110 into a condition to accept the write function. Subsequently, the user, by continuously indicating desired indication positions on the display surface 120A, inputs a handwritten line from a starting point (P₁) to a finishing point (P₂). On so doing, the controller 111, by specifying the function information expressing the write function allotted to the fifth operation point, and the position information from the starting point to the finishing point of the handwritten line, and storing them in the memory, can recognize overwrite information of the handwriting carried out by the user.

Meanwhile, when carrying out the operation shown in FIG. 7, the user firstly indicates the sixth operation point, putting the indication device 110 into a condition to accept the copy function. Next, the user, by indicating a desired indication position on the display surface 120A (in the case of the example, the position in which the characters forming “cat” are displayed), inputs the position of the characters to be copied. Subsequently, the user puts the indication device 110 into a condition to accept the paste function by indicating the seventh operation point, and indicates the position (P3) in which he or she desires to paste the previously copied characters. On so doing, the controller 111, by storing the function information expressing the copy function, the position information expressing the position in which the information which is the subject of the copying is displayed, the function information expressing the paste function, and the position information expressing the position which is the subject of the pasting, in the memory in the order in which they are input, can recognize overwrite information from the copy and paste carried out by the user. It is sufficient that the controller 111, in order to specify the information which is the subject of the copying, refers to the layout information stored in the storage unit 112.

Also, the controller 111, in the event that the specified indication position is one of the first to fourth operation points, carries out a process for supplying power and information to the display device 120. As the first to fourth operation points are operation points where the secondary coils 121 are provided over the primary coil 116, it is possible to electromagnetically couple them with the primary coil 116. For this reason, the controller 111 supplies the necessary power and information to the display device 120 only when one of the first to fourth operation points is indicated, and communication with the display device 120 is possible by means of an electromagnetic coupling.

### 2. Power and Information Supply

The indication device 110, when coming near one of the first to fourth operation points of the display device 120, supplies power and information to the display device 120. That is, the indication device 110, when coming near the secondary coils 121 of the display device 120, as well as carrying out communication via the secondary coils 121, supplies the power necessary for a rewriting of the display surface 120A. At this time, in the indication device 110, a supply of power and information to the display device 120 is carried out by the controller 111 retrieving the information stored in the memory and storage unit 112 and supplying it to the communication and power controller 115, and the communication and power controller 115 modulating the information, and supplying a current to the primary coil 116.

The information supplied by the controller 111 is display data expressing information to be displayed on the display unit 125. The controller 111 acquires the display data to be supplied to the display device 120 by retrieving them from the storage unit 112, or by generating them based on the display data stored in the storage unit 112. The controller 111 generates the display data in the event that the display data to be supplied are display data including overwrite information, while in cases other than this the controller 111 supplies the display data retrieved from the storage unit 112, as they are, to the display device 120.

The controller 111, prior to supplying the information, as well as specifying the function allotted to the operation point indicated by the user, refers to the context information in the storage unit 112, and specifies the display data being displayed by the display device 120. Then, the controller 111 executes a process appropriate to the specified function. In the event that the specified function is the page return function or the page forward function, the controller 111, based on the context information, specifies the identification information of the display data being displayed by the display device 120, specifies the display data to be displayed before or after those display data, retrieves the specified display data from the storage unit 112, and supplies them to the display device 120. Also, in the event that the specified function is the overwrite delete function, the controller 111, based on the context information, specifies the identification information of the display data being displayed by the display device 120, retrieves the specified display data from the storage unit 112, and supplies them to the display device 120.

Also, in the event that the specified function is the overwrite update function, the controller 111 generates new display data wherein overwrite information is added to the display data being displayed by the display device 120. That is, the new display data referred to here are display data expressing information wherein overwrite information is added to information being displayed by the display device 120 in such a way as to be superimposed thereon. At this time, the controller 111 recognizes the overwrite information based on the function information and position information stored in the memory, and executes a process of adding the recognized overwrite information to the display data.

The controller 111 supplies the display data for which a generation or retrieval has been carried out in the way heretofore described to the communication and power controller 115. The communication and power controller 115 supplies a current corresponding to a modulation wave based on the display data to the primary coil 116. In the display device 120, the secondary coils 121 emit a current in accordance with a change in the magnetic flux from the primary coil 116, and the communication and power controller 122 acquires the display data by demodulating the current. The communication and power controller 122 stores the acquired display data in the buffer 126, and requests the process controller 123 to start a rewriting. The process controller 123 drives the rewriting drive unit 127 in response to the request, causing it a rewriting of the information displayed on the display unit 125.

It is also acceptable that a data conversion is carried out on the display data in the indication device 110 or display device 120. The data conversion referred to here includes a compression process or an extension process. That is, the display data can be converted at an appropriate timing to an appropriate data format, such as a data format appropriate to storage in the storage unit 112, a data format appropriate to a transmission by means of electromagnetic coupling, or a data format appropriate to a description of layout information.

### 3. Information Projection

The indication device 110 projects information as necessary while an operation is being carried out by the user. The projection of information is carried out, for example, while the controller 111 is executing a process relating to a display, or after the execution by the controller 111 of a process relating to a display. It being acceptable that the projected information is execution detail (what kind of process is being executed) or an execution form (in what way the process is being executed) of a process relating to a display, or a result of the execution thereof, information is also acceptable which prompts an operation by the user.

Also, the indication device 110 needs a predetermined time until the supply of power and information is completed. It is acceptable that the indication device 110 carries out the projection of information to coincide with the time until the supply of power and information is completed. The information projected at this time is, for example, information expressing a communication condition.

FIGS. 8A to 8E are diagrams exemplifying information projected onto the indicated surface. In the diagrams, information displayed on the indicated surface is shown by solid lines, while projected information is shown by outline characters. FIG. 8A is a diagram exemplifying with a case of projecting copied characters. It is acceptable that the controller 111, in the event of specifying information copied using the copy function, projects the specified information as in the diagram. By so doing, it is possible to let the user ascertain whether or not the information intended by the user has been copied. It is also acceptable to arrange in such a way that, instead of the projection display shown in FIG. 8A, “o” is projected when it is possible to specify the character string which is the subject of the copying, and “x” when it is not possible, as shown in FIGS. 8B and 8C. Also, in the same way, it is also acceptable to arrange in such a way that “o” is projected when it is possible to recognize that an operation point has been indicated, and “x” when it is not possible.

FIGS. 8D and 8E are diagrams exemplifying information projected when communication is carried out between the indication device 110 and display device 120. As a predetermined time is needed to supply power and information, as heretofore described, in the event that the user moves the indication device 110 before the time elapses, there is a possibility that the power will not be sufficiently supplied, or that one portion of the information will be missing. Therein, in the event that one of the first to fourth operation points is indicated, it is acceptable to project characters or symbols urging the user not to move the indication device 110, as shown in FIG. 8D. Also, by projecting a degree of completion of the process as a percentage or the like, as shown in FIG. 8E, it is possible for the user to more easily ascertain the progress and finish of the process. Also, in the event of carrying out the kind of projection shown in FIG. 8E, the controller 111 switches the information projected at predetermined intervals (for example, one point intervals or five point intervals), projecting so that the information appears to be continually changing. Also, as an example of information continually changing, it is possible to include a projection of an image corresponding to a so-called wait cursor (a second timer or the like) in a graphical user interface (GUI).

Furthermore, it is also acceptable to notify the user of the function allotted to the position indicated by the user, as by, for example, projecting “copy” in the event that the operation point corresponding to the copy function (the sixth operation point) has been indicated.

In this case, it is also acceptable that the controller 111 decides to execute the function notified of after a predetermined time has elapsed from carrying out the projection for notifying the user. By so doing, it is possible to let the user confirm whether or not the process corresponding to the position which the user has indicated, and the process the user has intended, correspond. In this case, when the operation and the intended process do not correspond, it is possible for the user to move the indication device 110 to another place before the predetermined time elapses, canceling the input.

As heretofore described, according to the information projection system 10 of the embodiment, as it is possible to carry out a projection with the indication device 110 independently of a rewriting of the display device 120, it is possible to display projected information on the indicated surface, without rewriting the display details of the indicated surface. The following kinds of benefit can be expected from carrying out such a projection display.

As an information display by the display device 120 covers the whole of the display surface 110A, there is a problem in that a commensurate amount of power is consumed. Also, there is a problem in that, in order to rewrite the whole of the display surface 110A, a commensurate amount of time is consumed. These problems become particularly noticeable when attempting to configure the display surface 110A using a memory-type display medium. In response to this, the information projection system 10 of the embodiment, by carrying out a partial or temporary information display by means of a projection, achieves a benefit wherein it is possible to reduce the time and power consumed in comparison with a case of carrying out such an information display by means of a rewriting of the display surface 110A. In particular, this benefit is noticeable in a case in which the display device 120 is of a configuration which does not include a power source, as in the embodiment.

Also, as the indication device 110 of the embodiment is of a configuration which supplies (that is, transmits) display data to be displayed after a rewriting to the display device 120, the indication device 110 can, without receiving a supply of information relating to display details from the display device 120, specify the display details. Thus, the indication device 110 can project differing information depending on the display details. The controller 111 of the indication device 110, when specifying the display details of the display device 120, refers to the layout information, and identifies the display details of the display surface 120A based on the layout information. That is, the controller 111 functions here as the identification unit 111b which identifies the information displayed on the display surface 120A.

### Second Embodiment

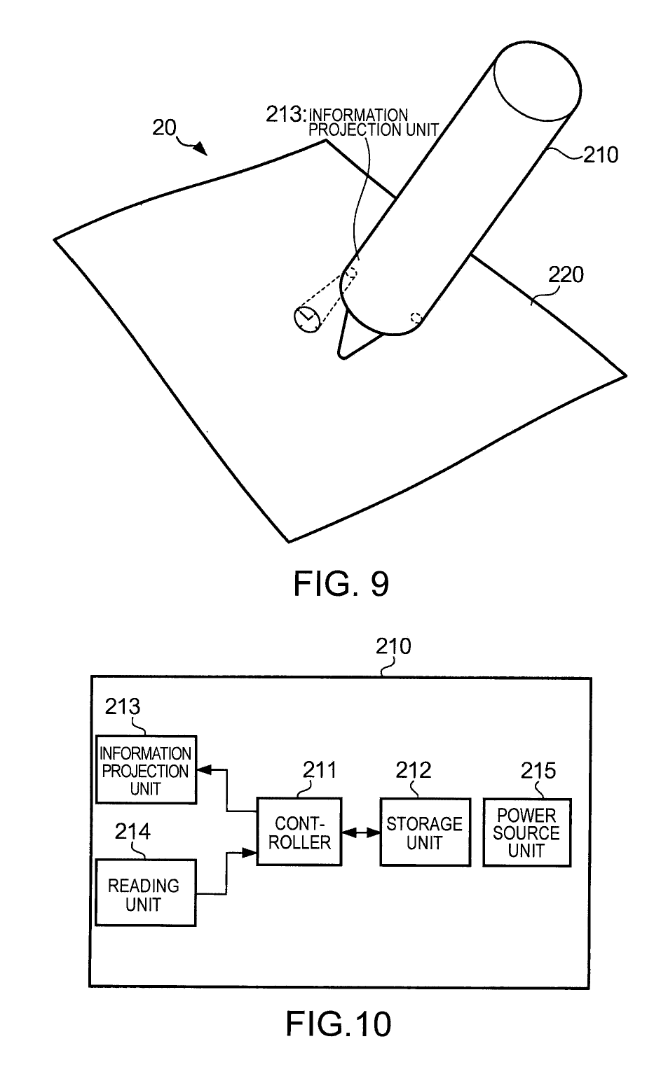

FIG. 9 is a diagram showing a configuration of an information projection system which is a second embodiment of the invention. As shown in the diagram, an information projection system 20 of the embodiment includes an indication device 210, and a display carrier 220. Although the external appearance of the indication device 210 is the same as that of the indication device 110 of the first embodiment, the internal configuration differs from that of the indication device 110. The display carrier 220 is a paper surface as defined in the invention. Therefore, the display carrier 220, unlike the display device 120 of the first embodiment, does not have a way of rewriting its display details, or a way of communicating with the indication device 210. The same kinds of code information and characters as on the display surface 120A of the first embodiment are displayed, by printing or the like, on the indicated surface of the display carrier 220. It is more desirable that the code information is of an appearance more difficult to see than that of the characters.

FIG. 10 is a block diagram showing a configuration of the indication device 210. As shown in the diagram, the indication device 210 includes a controller 211, a storage unit 212, an information projection unit 213, a reading unit 214, and a power source unit 215. Although the indication device 210 differs from the indication device 110 of the first embodiment from the point of not having a configuration corresponding to the communication and power controller 115 and primary coil 116, other configurations are approximately identical to those of the indication device 110. Each unit of the indication device 210 is of the same configuration as each unit of the indication device 110 described with the same name thereas. However, processes executed by the controller 211, and information stored by the storage unit 212, differ from those of the first embodiment.

The indication device 210 of the embodiment is one which displays by projection other information corresponding to information displayed on the display carrier 220. In the embodiment, the information displayed on the display carrier 220 is an English sentence, while the corresponding other information is the English sentence translated into Japanese. For the sake of the description, hereafter, the English sentence displayed on the display carrier 220 will be referred to as “the original”, while the Japanese sentence corresponding thereto will be referred to as “the translation”.

The storage unit 212 stores layout information. The layout information of the embodiment is information in which each position (coordinates) on the indicated surface, and a character string of the translation corresponding to a character string of the original displayed in each position, are described correlated. The controller 211, by referring to the translation information, can specify the character string of the translation corresponding to the character string of the original displayed in a certain position.

The configuration of the information projection system 20 of the embodiment is as heretofore described. With this configuration, in the information projection system 20, the indication device 210 displays by projection the translation corresponding to the original displayed on the display carrier 220. The indication device 210 projects only a character string corresponding to a position indicated by the user. For example, in the event that the user indicates the position on the display carrier 220 in which the character string forming “cat” is displayed, the controller 211 projects a character string forming “neko” in the vicinity of the indicated position. That is, a projection with the indication device 210 is performed not on a whole of the indicated surface of the display carrier 220, but on one portion. Also, the indication device 210, in the event that the indication position is changed by the user, alters the projected translation character string in response to the change.

The process carried out by the indication device 210 in order to project is as follows. Firstly, the reading unit 214 carries out a reading of the indicated surface in response to an operation by the user and, by specifying the corresponding code information from the image data read, specifies the indication position thereof. Continuing, the controller 211, by referring to the layout information, specifies the translation character string corresponding to the specified indication position. The controller 211, on specifying the translation character string, supplies the specified character string to the information projection unit 213, causing it to be projected.

As heretofore described, according to the information projection system 20 of the embodiment, in the case in which the indicated surface is a paper surface too, it is possible to display by projection information corresponding to the information displayed on the indicated surface.

It is also acceptable that the information projection system 20 of the embodiment is of a configuration such that the displayed information uses a plurality of differing display carriers 220. In this case, it is sufficient that the indication device 210, as well as storing a plurality of items of layout information, corresponding one to each of the display carriers 220, in the storage unit 212, is provided with a way of specifying which of the display carriers 220 is the one indicated by the user. The way of specifying the display carrier 220 can be realized by causing the reading unit 214 to read information unique to each of the display carriers 220, or by the user inputting using a manipulator such as a button.

### MODIFICATION EXAMPLES

The invention can be implemented in forms differing from the heretofore described embodiments. The modification examples shown hereafter are examples of modifications applicable to the invention. It is also acceptable that these modifications, when necessary, are implemented by appropriately combining with each other.

### 1. Modification Example 1

The indication device according to some aspects of the invention, by acquiring position information such as code information, can project information appropriate to the acquired position information. However, the indication device according to some aspects of the invention can also project other information which has no relation to the position information, and it is also possible to adopt a configuration such that the indication device does not acquire position information in such a case. Herein, the other information can include, for example, the amount of electrical discharge the power source unit can discharge (the so-called remaining battery charge). Also, it is also acceptable that the indication device according to some aspects of the invention, in the event that there is insufficient memory, projects notification thereof, and it is also acceptable that the indication device projects information telling the user what kind of operation should be carried out.

Also, it is also acceptable that the indication device according to some aspects of the invention changes the display form of the projected information depending on whether a certain area included in the indicated surface is being indicated or another area is being indicated. For example, it is acceptable to arrange in such a way that the indication device according to some aspects of the invention projects a certain image (such as an image simulating a human hand or finger) in the event that a specific area of the indicated surface has been indicated, and projects another image (such as an image of an arrow) in the event that another area has been indicated. This is a procedure of displaying a cursor on a screen in a GUI.

### 2. Modification Example 2

In the invention, in the event that the indication device and display device communicate, the form of the communication is not limited to that of the first embodiment. For example, it is also acceptable to connect the indication device and display device using a conductive wire, and carry out a wired communication. Also, in the event that the indication device and display device communicate, it being sufficient that the indication device includes a configuration corresponding to the information projection unit 113 and reading unit 114, it is acceptable that another configuration corresponding to the controller 111 and storage unit 112 is included in the display device. In the heretofore described display device 120 of the first embodiment, the process controller 123 and storage unit 124 qualify as a configuration corresponding to the controller 111 and storage unit 112. That is, a function corresponding to the process execution unit of some aspects of the invention, which executes a process appropriate to an indication position, can be included in either one of the indication device or display device. Also, it is also acceptable that the process execution unit of some aspects of the invention is realized by a process execution unit of the indication device (a first process execution unit) and a process execution unit of the display device (a second process execution unit) moving in concert.

### 3. Modification Example 3

The invention, in the event of including the plurality of secondary coils 121 as in the heretofore described first embodiment, can use them as a way of specifying the indication position. In the event of specifying the indication position using the secondary coils 121, it is necessary to provide a detection unit 130 which detects which secondary coil 121, among the plurality of secondary coils 121, has been indicated, as shown in FIG. 12. The detection unit 130 is realized by, for example, measuring the current generated in the plurality of secondary coils 121 corresponding to a plurality of indication positions. According to the detection unit 130, it is possible to specify that the secondary coil 121 in which the measured current reaches the highest level is the one indicated.

The heretofore described detection unit 130 is one which carries out the detection of the indication position utilizing electromagnetic induction, but it is also acceptable that the detection unit of some aspects of the invention detects the indication position utilizing another physical phenomenon. For example, in the invention, it is also acceptable to detect the indication position by the indication device emitting a predetermined light, and the display device accepting the light. Therefore, the concept of “electromagnetic wave” in some aspects of the invention also including this kind of light, the concept of “electromagnetic wave generator” in some aspects of the invention also includes a light emitting article.

### 4. Modification Example 4

The heretofore described second embodiment is such that characters are displayed on the display carrier 220, and corresponding characters are projected using the indication device 210, but information displayed or projected in the invention is not limited to characters. For example, it is also acceptable that, in the event that the user has indicated the character string forming “cat” displayed on the display carrier 220, a picture of a cat is projected in the vicinity of the position in which the character string is displayed. Also, for example, it is also acceptable that a map is displayed on the display carrier 220, and the indication device 210 projects an additional character or image appropriate to the indication position. In short, it is sufficient that the information displayed on the display carrier 220 and the information projected by the indication device 210 have a correspondence relation decided in advance.

### 5. Modification Example 5

In the invention, it is also acceptable that the secondary coils 121, not being limited to the operation surface 120B, are provided in positions aligned below the display surface 120A. In this case, it is also acceptable that the functions allotted to the secondary coils 121 are changed in accordance with a change in the display details of the display surface 120A. It is also acceptable that the change of the functions allotted to the secondary coils 121 is carried out in cases other than when the secondary coils 121 are provided in positions aligned below the display surface 120A.

### 6. Modification Example 6

In the heretofore described embodiments, operation points (the first to fourth operation points) below which the secondary coils 121 are aligned, and operation points (the fifth to seventh operation points) below which the secondary coils 121 are not aligned are described, but it is also acceptable to make the fifth to seventh operation points operation points below which the secondary coils 121 are aligned. In the case of adopting this kind of configuration, as it is possible to specify the function allotted to each operation point by indicating the operation point, information corresponding to the heretofore described function information is unnecessary.

Japanese Patent Application Nos. 2008-100055 filed on Apr. 4, 2008 and 2009-011674 filed on Jan. 22, 2009 are hereby incorporated by reference in its entirety.

What is claimed is:

1. An indication device comprising:
an indication unit pointing to an indication position which is a position on an indicated surface on which first information is displayed;
an information projection unit which projects second information onto the indicated surface; and
a process execution unit which executes a process appropriate to an indication position pointed to by the indication unit.

2. The indication device according to claim 1, wherein
the information projection unit projects information in accordance with execution details, an execution form, or an execution result of a process by the process execution unit as the second information.

3. The indication device according to claim 1 further comprising:
a storage unit which stores the second information corresponding to the first information for each position in which the first information is displayed; and
a specification unit which specifies the indication position pointed to by the indication unit, wherein
the process execution unit retrieves the second information corresponding to the indication position specified by the specification unit from the storage unit, and supplies it to the information projection unit, and
the information projection unit projects the second information supplied by the process execution unit.

4. The indication device according to claim 1, wherein
the indication unit changes the indication position in response to an operation by a user, and
the information projection unit projects information prompting an operation by the user.

5. An information projection system comprising:
an indication device having:
an indication unit pointing to an indication position which is a position on an indicated surface on which first information is displayed;
a first process execution unit which executes a process appropriate to an indication position pointed to by the indication unit; and
an information projection unit which projects second information onto the indicated surface; and
a display device having:
a display unit which displays the first information on the indicated surface; and
a second process execution unit which executes a process appropriate to an indication position pointed to by the indication unit.

6. The information projection system according to claim 5, wherein
the indication device has:
a first communication unit which carries out communication with the display device; and
a reading unit which reads position information expressing the indication position pointed to by the indication unit, wherein
the first process execution unit transmits the position information read by the reading unit, or display information corresponding to the position information, via the first communication unit to the display device, and
the display device has:
a second communication unit which carries out communication with the indication device; and
a rewriting drive unit which rewrites the first information displayed by the display unit, wherein
the second process execution unit causes the rewriting drive unit to carry out a rewriting in accordance with the position information or display information received from the indication device via the second communication unit.

7. The information projection system according to claim 5, wherein
the indication device has:
an electromagnetic wave generator which generates an electromagnetic wave, and
the display device has:
a detection unit which detects the electromagnetic wave generated by the electromagnetic wave generator in a plurality of positions on the indicated surface, and
the rewriting drive unit which rewrites the first information displayed by the display unit, wherein
the second process execution unit causes the rewriting drive unit to carry out a rewriting in accordance with the position in which the detection unit detects the electromagnetic wave.

8. The information projection system according to claim 6, wherein
the information projection unit carries out a projection in response to a reading of the position information or display information by the reading unit.

9. The information projection system according to claim 6, wherein
the indication device includes an identification unit which identifies the first information displayed on the indicated surface after the rewriting by the rewriting drive unit, and
the information projection unit carries out a projection in accordance with the identification by the identification unit.

10. The information projection system according to claim 6, wherein
the information projection unit carries out a projection in accordance with the condition of the communication by the first and second communication units.

11. The information projection system according to claim 6, wherein
the first communication unit has a primary coil which generates an electromagnetic wave,
the second communication unit has secondary coils, in a plurality of differing positions, which are electromagnetically coupled with the primary coil, and
the second process execution unit varies the form of the rewriting in accordance with the position of the secondary coil electromagnetically coupled with the primary coil.
